(19) United States
(12) Patent Application Publication
(10) Pub. No.: US 2026/0052405 A1
(43) Pub. Date: Feb. 19, 2026

(54) TECHNIQUES FOR NETWORK MISCONFIGURATION REPORTING

(71) Applicant: QUALCOMM Incorporated, San Diego, CA (US)

(72) Inventors: Soo Bum LEE, San Diego, CA (US); Gavin Bernard HORN, La Jolla, CA (US)

(21) Appl. No.: 18/809,142

(22) Filed: Aug. 19, 2024

(51) Int. Cl. H04W 24/08; H04W 8/22; H04W 24/02

(52) U.S. Cl. CPC H04W 24/08; H04W 8/22; H04W 24/02

(57) ABSTRACT

Methods, systems, and devices for method for wireless communication are described. A user equipment (UE) may receive, from a first network entity, a request to report one or more network configuration parameters associated with monitoring for a potential network misconfiguration of one or more network functions at the UE. The UE may further receive, from a serving cell or from a neighbor cell, control signaling indicating the one or more network configuration parameters associated with the one or more network functions at the UE. In some examples, the UE may transmit, to a second network entity in response to the request, a report indicating the one or more network configuration parameters. The UE may then receive, from the first network entity and based on the report, at least one updated network configuration parameter corresponding to at least one network function of the one or more network functions.

### FIELD OF TECHNOLOGY

The following relates to method for wireless communication, including techniques for network misconfiguration reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a first network entity, a request to report one or more network configuration parameters associated with monitoring for a potential network misconfiguration of one or more network functions at the UE, receiving, from a serving cell or from a neighbor cell, control signaling indicating the one or more network configuration parameters associated with the one or more network functions at the UE, transmitting, to a second network entity in response to the request, a report indicating the one or more network configuration parameters, and receiving, from the first network entity and based on the report, at least one updated network configuration parameter corresponding to at least one network function of the one or more network functions.

A UE for wireless communications is described. The UE may include one or more memories storing processor executable code, and one or more processors coupled with the one or more memories. The one or more processors may individually or collectively be operable to execute the code to cause the UE to receive, from a first network entity, a request to report one or more network configuration parameters associated with monitoring for a potential network misconfiguration of one or more network functions at the UE, receive, from a serving cell or from a neighbor cell, control signaling indicating the one or more network configuration parameters associated with the one or more network functions at the UE, transmit, to a second network entity in response to the request, a report indicating the one or more network configuration parameters, and receive, from the first network entity and based on the report, at least one updated network configuration parameter corresponding to at least one network function of the one or more network functions.

Another UE for wireless communications is described. The UE may include means for receiving, from a first network entity, a request to report one or more network configuration parameters associated with monitoring for a potential network misconfiguration of one or more network functions at the UE, means for receiving, from a serving cell or from a neighbor cell, control signaling indicating the one or more network configuration parameters associated with the one or more network functions at the UE, means for transmitting, to a second network entity in response to the request, a report indicating the one or more network configuration parameters, and means for receiving, from the first network entity and based on the report, at least one updated network configuration parameter corresponding to at least one network function of the one or more network functions.

A non-transitory computer-readable medium storing code for wireless communications is described. The code may include instructions executable by one or more processors to receive, from a first network entity, a request to report one or more network configuration parameters associated with monitoring for a potential network misconfiguration of one or more network functions at the UE, receive, from a serving cell or from a neighbor cell, control signaling indicating the one or more network configuration parameters associated with the one or more network functions at the UE, transmit, to a second network entity in response to the request, a report indicating the one or more network configuration parameters, and receive, from the first network entity and based on the report, at least one updated network configuration parameter corresponding to at least one network function of the one or more network functions.

In some examples of the method, UEs, and non-transitory computer-readable medium described herein, transmitting the report may include operations, features, means, or instructions for transmitting the report indicating a first network configuration parameter in addition to the one or more network configuration parameters, where the first network configuration parameter may be associated with a potential network misconfiguration detected at the UE.

Some examples of the method, UEs, and non-transitory computer-readable medium described herein may further include operations, features, means, or instructions for identifying the first network configuration parameter may be associated with the potential network misconfiguration based on a value of the first network configuration parameter indicated in the control signaling differing from a historical value of the first network configuration parameter or differing from a value indicated by one or more neighbor cells.

In some examples of the method, UEs, and non-transitory computer-readable medium described herein, a difference between the value of the first network configuration parameter indicated in the control signaling and the historical value of the first network configuration parameter satisfies a first threshold and a difference between the value of the first network configuration parameter indicated in the control signaling and the value indicated by the one or more neighbor cells satisfies a second threshold, or both.

Some examples of the method, UEs, and non-transitory computer-readable medium described herein may further include operations, features, means, or instructions for receiving an indication of a reporting period for transmitting the report indicating the one or more network configuration parameters, where the report may be transmitted within the reporting period.

Some examples of the method, UEs, and non-transitory computer-readable medium described herein may further include operations, features, means, or instructions for receiving a system information block indicating a probability for transmitting the report indicating the one or more network configuration parameters, where the report may be transmitted based on the one or more network configuration parameters based on the probability.

Some examples of the method, UEs, and non-transitory computer-readable medium described herein may further include operations, features, means, or instructions for receiving a system information block indicating a timer for transmitting the report indicating the one or more network configuration parameters, where the report may be transmitted based on expiration of the timer.

In some examples of the method, UEs, and non-transitory computer-readable medium described herein, the one or more network configuration parameters include at least one of a master information block parameter, a system information block parameter, a radio resource control configuration parameter, a deviation from neighboring cells, a deviation from one or more historical configurations, or any combination thereof.

Some examples of the method, UEs, and non-transitory computer-readable medium described herein may further include operations, features, means, or instructions for transmitting a capability report indicating that the UE may be capable of transmitting the report or identifying a potential network misconfiguration or both, where the request may be received based on the capability report.

In some examples of the method, UEs, and non-transitory computer-readable medium described herein, the request may be based on a state of the UE or a power level at the UE or both.

In some examples of the method, UEs, and non-transitory computer-readable medium described herein, the at least one updated network configuration parameter may be included in at least one of a system information block message, a radio resource control message, or a non-access stratum message.

Some examples of the method, UEs, and non-transitory computer-readable medium described herein may further include operations, features, means, or instructions for communicating one or more messages with the serving cell or the neighbor cell based on the at least one updated network configuration parameter.

In some examples of the method, UEs, and non-transitory computer-readable medium described herein, the request includes an identifier associated with the second network entity receiving the report indicating the one or more network configuration parameters.

In some examples of the method, UEs, and non-transitory computer-readable medium described herein, the first network entity and the second network entity may be collocated and the first network entity and the second network entity may be same..

A method for wireless communications by a network entity is described. The method may include outputting a request for a UE to report one or more network configuration parameters associated with monitoring for a potential network misconfiguration of one or more network functions at the UE, outputting control signaling indicating the one or more network configuration parameters associated with the one or more network functions at the UE, and outputting, based on a report indicating the one or more network configuration parameters, at least one updated network configuration parameter corresponding to at least one network function of the one or more network functions.

A network entity for wireless communications is described. The network entity may include one or more memories storing processor executable code, and one or more processors coupled with the one or more memories. The one or more processors may individually or collectively be operable to execute the code to cause the network entity to output a request for a UE to report one or more network configuration parameters associated with monitoring for a potential network misconfiguration of one or more network functions at the UE, output control signaling indicating the one or more network configuration parameters associated with the one or more network functions at the UE, and output, based on a report indicating the one or more network configuration parameters, at least one updated network configuration parameter corresponding to at least one network function of the one or more network functions.

Another network entity for wireless communications is described. The network entity may include means for outputting a request for a UE to report one or more network configuration parameters associated with monitoring for a potential network misconfiguration of one or more network functions at the UE, means for outputting control signaling indicating the one or more network configuration parameters associated with the one or more network functions at the UE, and means for outputting, based on a report indicating the one or more network configuration parameters, at least one updated network configuration parameter corresponding to at least one network function of the one or more network functions.

A non-transitory computer-readable medium storing code for wireless communications is described. The code may include instructions executable by one or more processors to output a request for a UE to report one or more network configuration parameters associated with monitoring for a potential network misconfiguration of one or more network functions at the UE, output control signaling indicating the one or more network configuration parameters associated with the one or more network functions at the UE, and output, based on a report indicating the one or more network configuration parameters, at least one updated network configuration parameter corresponding to at least one network function of the one or more network functions.

In some examples of the method, network entities, and non-transitory computer-readable medium described herein, the report indicates a first network configuration parameter in addition to the one or more network configuration parameters and the first network configuration parameter may be associated with a potential network misconfiguration detected at the UE.

Some examples of the method, network entities, and non-transitory computer-readable medium described herein may further include operations, features, means, or instructions for receiving, from a second network entity, a request to configure the UE to report the one or more network configuration parameters.

In some examples of the method, network entities, and non-transitory computer-readable medium described herein, the network entity and the second network entity may be collocated and the network entity and the second network entity may be same.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for network misconfiguration reporting in accordance with one or more aspects of the present disclosure.

FIG. 2 shows an example of a wireless communications system that supports techniques for network misconfiguration reporting in accordance with one or more aspects of the present disclosure.

FIG. 3 shows an example of a process flow that supports techniques for network misconfiguration reporting in accordance with one or more aspects of the present disclosure.

FIGS. 4 and 5 show block diagrams of devices that support techniques for network misconfiguration reporting in accordance with one or more aspects of the present disclosure.

FIG. 6 shows a block diagram of a communications manager that supports techniques for network misconfiguration reporting in accordance with one or more aspects of the present disclosure.

FIG. 7 shows a diagram of a system including a device that supports techniques for network misconfiguration reporting in accordance with one or more aspects of the present disclosure.

FIGS. 8 and 9 show block diagrams of devices that support techniques for network misconfiguration reporting in accordance with one or more aspects of the present disclosure.

FIG. 10 shows a block diagram of a communications manager that supports techniques for network misconfiguration reporting in accordance with one or more aspects of the present disclosure.

FIG. 11 shows a diagram of a system including a device that supports techniques for network misconfiguration reporting in accordance with one or more aspects of the present disclosure.

FIGS. 12 through 15 show flowcharts illustrating methods that support techniques for network misconfiguration reporting in accordance with one or more aspects of the present disclosure.

### DETAILED DESCRIPTION

In some wireless communications systems, a network entity may configure one or more parameters for UEs to use in communication. In some cases, there may be a network entity-generated misconfiguration (e.g., network misconfiguration). A network misconfiguration may have security impacts in wireless communications systems. For instance, a network misconfiguration may include a misconfiguration of a synchronization signal block. In some examples, a UE may report one or more network parameters to enhance network performance or for network automation. In some cases, a UE may detect network misconfiguration based on the one or more network parameters. However, identifying such network parameters locally, without reporting the network parameters for detecting the network misconfiguration (e.g., misconfiguration of system information block), may impact network performance. Additionally, an undetected network misconfiguration may have lasting security impacts in a wireless communications systems. For instance, a network misconfiguration may lead to security issues due to misconfigurations such as accidentally configuring ciphering to be turned off, integrity protection being turned off, no validation of UE security capability (e.g., accepting UE reporting NULL algorithms), no fresh globally unique temporary identity (GUTI) allocation or sequence number allocation, among others, or any combination thereof.

One or more aspect of the present disclosure provides for reporting one or network configuration parameters for potential network misconfiguration detection and reporting. In some examples, a UE may receive a request to report one or more network configuration parameters associated with monitoring for a potential network misconfiguration of one or more network functions at the UE. For instance, a first network entity may request the UE to report the one or more network configuration parameters. In some examples, a second network entity may select one or more UEs based on the UE capabilities, and may request the first network entity to configure the selected UEs to report the one or more network configuration parameters.

In some examples, the UE may receive control signaling indicating the one or more network configuration parameters associated with the one or more network functions at the UE. In some examples, the UE may transmit, to the second network entity and in response to the request, a report indicating the one or more network configuration parameters. The second network entity may determine a misconfiguration by comparing the UE report with a network configuration. In some cases, the second network entity may obtain the network configuration from the first network entity. Alternatively, the second network entity may obtain the network configuration from a third network entity which may configure the first network entity. The UE may then receive, from the first network entity and based on the report, at least one updated network configuration parameter corresponding to at least one network function of the one or more network functions.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to techniques for network misconfiguration reporting.

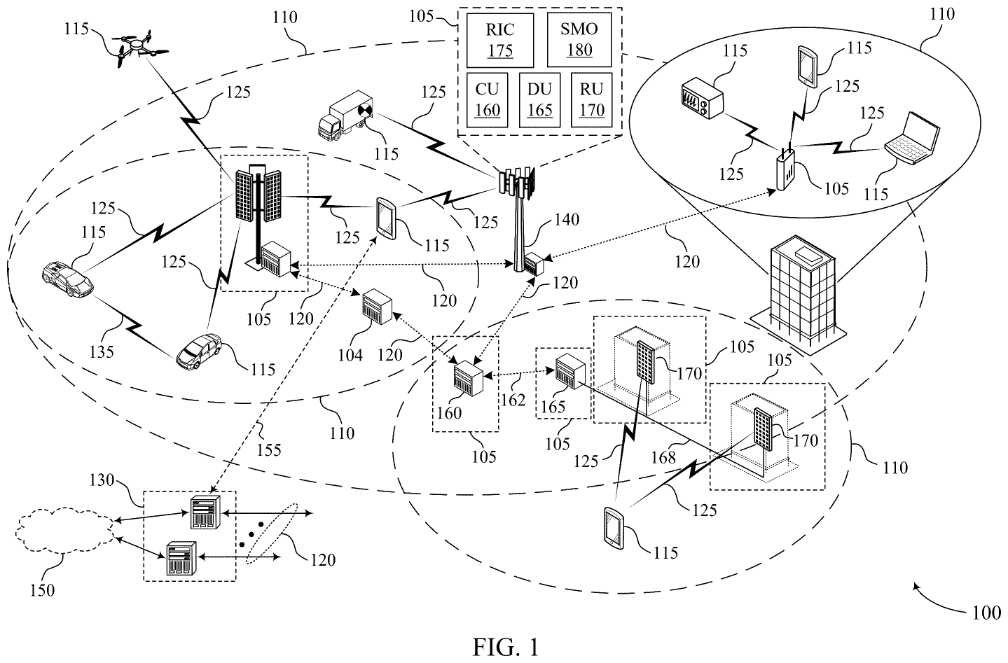

FIG. 1 shows an example of a wireless communications system 100 that supports techniques for network misconfiguration reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, inability to identify network misconfiguration may result in an impact to user experience and a loss in communication resources. In some examples, a UE 115 may report one or more parameters to enhance network performance or for network automation. However, misconfiguration (e.g., misconfiguration of system information block), although may be detected at the UE 115-a, may have local significance. For instance, a UE 115 may not determine certainly whether it is misconfiguration or not (i.e., whether such configuration is intended by the network). In some examples, network misconfiguration may lead to security issues like accidental ciphering off, integrity protection off, no validation of UE security capability (e.g., accepting UE reporting NULL algorithms), no fresh GUTI allocation or sequence number allocation, etc.

Aspects of the present disclosure provide for potential network misconfiguration detection and reporting. In some examples, a UE 115 may receive, from a first network entity 105, a request to report one or more network configuration parameters associated with monitoring for a potential network misconfiguration of one or more network functions at the UE 115. The UE 115 may receive, from a serving cell or from a neighbor cell, control signaling indicating the one or more network configuration parameters associated with the one or more network functions at the UE 115. In some examples, the UE 115 may transmit, to a second network entity 105 and in response to the request, a report indicating the one or more network configuration parameters. The UE 115 may then receive, from the first network entity and based on the report, at least one updated network configuration parameter corresponding to at least one network function of the one or more network functions.

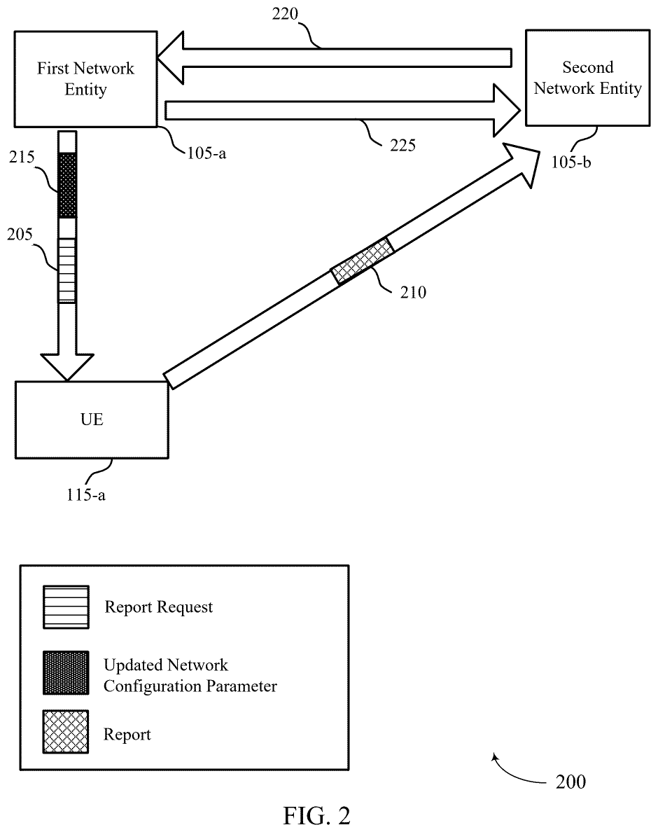

FIG. 2 shows an example of a wireless communications system 200 that supports techniques for network misconfiguration reporting in accordance with one or more aspects of the present disclosure. The wireless communications system 200 may implement or may be implemented by aspects of the wireless communications system 100. For example, the wireless communications system 200 may include a UE 115-a, a first network entity 105-a, and a second network entity 105-b, which may be examples of corresponding devices described with reference to FIG. 1. In some examples, the first network entity 105-a and the second network entity 105-b may be co-located. In some examples, the first network entity 105-a and the second network entity 105-b may be the same.

In some examples, the UE 115-a and the network entities 105 may support identifying potential network misconfiguration. In some cases, the UE 115-a and the network entities 105 may leverage a data collection framework to identify potential network misconfiguration and update network configuration. In particular, the first network entity 105-a and the second network entity 105-b may leverage a data collection framework to configure one or more UEs to report network configuration data (e.g., via system information blocks). In some cases, a wireless communications system 200 may enable a network function or network server to analyze or identify misconfiguration based on one or more UE reports.

In some cases, the first network entity 105-a or the second network entity 105-b or both, may reconfigure a network (i.e., related network functions) with correct parameters based on receiving a report associated with potential network misconfiguration. The first network entity 105-a or the second network entity 105-b or both may inform UEs of a correct configuration (via RRC signaling, or NAS signaling) or a system information block change indication. For example, a network misconfiguration may indicate that the UE 115-a is not to use ciphering for a data of a message, and the first network entity 105-a or the second network entity 105-b or both may inform of the correct configuration to use ciphering.

In some examples, depending on how data collection is enabled, the UE 115-a may transmit a report indicting one or more network configurations in a control plane (e.g., via NAS or RRC) or over a user plane. In some examples, the report may be transported to a data collection entity (e.g., in operations and management (OAM)) that collects misconfiguration reports. In some cases, the UE 115-a may be capable of implementing on-device artificial intelligence or machine learning feature to identify potential misconfiguration. The UE 115-a may identify one or more parameters and/or behavior to help identify potential misconfiguration by leveraging historical network configuration patterns.

Data collection in the wireless communications systems 200 may be implemented using a core network data collection entity, a RAN data collection entity and a UE data collection entity. The core network data collection entity may support network data analytics function and may have a core network impact and a UE impact. The core network data collection entity may support an analytics data repository function. In some examples, the RAN data collection entity may support self-organizing networks (SON), minimization of drive test (MDT), and a quality of experience (QoE) procedures. The RAN data collection entity may have RAN and UE impacts. In some examples of the RAN data collection entity, collected data may be stored at a trace collection entity or a QoE metrics collection entity. In some examples, the UE data collection entity may support data that is collected as part of SON, MDT, or QOE procedures and logs. In some examples, the UE 115-a may report an indication of data collection upon establishing a connection with a network entity. In some examples, the storage in a UE may be limited.

In some examples, an operator managed data collection at the UE may enable data exposure for operator and third party services. In some cases, a data collection services may include a data collection authorization entity that determines which data the UE is authorized to report based on the device capabilities and a service level agreement (SLA) between the operator and the customer. Additionally, the data collection services may include a data collection controller (e.g., campaign manager) that selects which UEs are chosen to collect data and configures which data is to be reported and how or where to report. In some examples, the data collection services may include a data storage (e.g., data lake) that stores the data collected from the UE.

In some examples, the operator managed data collection at the UE may include a device management client that registers for data collection and configured by the data collection controller (including the address(es) of the data storage for reporting. The device management client may report the data to the network. In some cases, the operator managed data collection at the UE may include consent management services including a data governance service or a data governance client which provides an interface to the user to manage the user consent among other data governance procedures. Additionally, the operator managed data collection at the UE may include a user subscription information storage that hosts subscription information including consent profile.

The wireless communications system 200 may support data collection (e.g., data collection at the UE 115-a or data collection at another device). The data collection may be implemented by a device management client, a data storage, a data collection controller, a data collection authorization, and a data consumer. The device management client may register at the data collection authorization function. The device management client may be configured with the address of a data collection controller. In some examples, the device management client may be configured with which data is authorized to be collected. The data consumer, in some examples, may subscribe for data to a data collection controller (e.g., campaign manager). The data collection controller may configure the device management client and the data may be reported to data storage and forwarded to the data consumer. Optionally, the data may be reported after data processing at the device management client and/or data storage.

According to the one or more aspects depicted herein, the UE 115-a may receive a request 205 to report one or more network configuration parameters associated with monitoring for a potential network misconfiguration of one or more network functions at the UE 115-a. In some examples, the UE 115-a may receive the request based on capability information associated with the UE 115-a. For example, the UE 115-a may transmit a capability report indicating that the UE 115-a is capable of transmitting the report or identifying a potential network misconfiguration or both. In such cases, the request 205 may be received based on the capability report. The UE 115-a may receive the request 205 from the first network entity 105-a. In some cases, the UE 115-a may receive the request 205 from the second network entity 105-b. In some examples, the UE 115-a may receive control signaling indicating the one or more network configuration parameters associated with the one or more network functions at the UE 115-a. In some cases, the UE 115-a may receive the control signaling from a serving cell or from a neighbor cell. The UE 115-a may transmit a report 210 indicating the one or more network configuration parameters to a second network entity 105-b. Although depicted as transmitting to the second network entity 105-b, in some examples, the UE 115-a may transmit the report to the first network entity 105-a. The report 210 may indicate a potential network misconfiguration. In some examples, the UE 115-a may receive, from the first network entity 105-a and based on the report, at least one updated network configuration parameter 215 corresponding to at least one network function of the one or more network functions.

As described herein, a network entity may determine what contents to include in the report 210. In some examples, the content may include at least one of a potential list of one or more network misconfigurations, a master information block information, a system information block information, one or more RRC configuration parameters, a potentially abnormal configuration based on UE detection, a deviation from one or more neighbor cells, a deviation from historical configuration, or any combination thereof.

In some examples, a network entity (e.g., the first network entity105-a or the second network entity 105-b) may select and transmit control signaling to configure one or more UEs to report one or more network configurations. In some examples, the second network entity 105-b may select the group of UEs (that are configured to report network configuration parameters indicating potential network misconfiguration). In some examples, the second network entity 105-b may indicate such selection of UEs to the first network entity 105-a via communication link 220. The first network entity 105-a may transmit the request 205 for the UE 115-a to report one or more network configuration parameters based on receiving the selection indication from the second network entity 105-b. In some examples, a network entity may select or configure a UE to report based on at least one of one or more UE capabilities, one or more UE states, a UE power level, or any combination thereof. In some examples, not all UEs may report the same data.

In some examples, the UE 115-a may employ one or more artificial intelligence modules at the UE 115-a to detect a potential misconfiguration. As discussed herein, misconfiguration detection at the UE 115-a may be based on any configuration that deviates from one or more historically normal configuration patterns. In some examples, such information may be stored in the UE as a digest (e.g., hash) or such information may be stored at cloud (e.g., third party service) for lookup. The UE 115-a may identify a configuration as a potential network configuration based on the configuration the configuration being different (more than a threshold) from that of one or more neighbor cells. In some examples, the UE 115-a may evaluate one or more of a system information block, RRC, or NAS configuration, for reporting. The UE 115-a may categorize a configuration as a potential misconfiguration based on an abrupt change of network configuration in mobility or network (re)-selection or cell (re)-selection, or any combination thereof. Such abrupt change of network configuration may be due to connection, connection failure, lost signal, jamming, or any combination thereof.

In some examples, the UE 115-a may transmit the report 210 indicating a first network configuration parameter in addition to the one or more network configuration parameters. In some examples, the first network configuration parameter may be associated with a potential network misconfiguration detected at the UE 115-a. In such cases, the UE 115-a may identify that the first network configuration parameter is associated with the potential network misconfiguration based on a value of the first network configuration parameter indicated in the control signaling differing from a historical value of the first network configuration parameter or differing from a value indicated by one or more neighbor cells. In some examples, a difference between the value of the first network configuration parameter indicated in the control signaling and the historical value of the first network configuration parameter may satisfy a first threshold. Additionally, or alternatively, a difference between the value of the first network configuration parameter indicated in the control signaling and the value indicated by the one or more neighbor cells may satisfy a second threshold.

According to one or more aspects of the present disclosure, the second network entity 105-b may identify a potential misconfiguration (e.g., based on the report 210). A network configuration analytics function that has collected one or more UE reports (located in the second network entity 105-b or separate from the second network entity 105-b) may analyze the configuration reported by one or more UEs. In some examples, the network configuration analytics function may be included in an OAM. Alternatively, the network configuration analytics function may a separate logical function than the one configures network functions (e.g., gNB, eNB, CU, DU, etc.).

Upon detection of misconfiguration, the network (e.g., OAM) may reconfigure the corresponding network functions with one or more correct parameters (e.g., based on crowd sourcing). The network may reconfigure one or more UEs using one or more system information blocks, RRC signaling, NAS signaling, or any combination thereof. The UE 115-a may receive, from the first network entity 105-a and based on the report 210, at least one updated network configuration parameter corresponding to at least one network function of the one or more network functions. The first network entity 105-a, in some examples, may receive an indication of the updated network configuration parameter from the second network entity 105-b (via communication link 225). In some examples, after receiving the updated network configuration parameter, the UE 115-a may communicate with the serving cell or the neighboring cell.

In some examples, the UE 115-a may determine when to report the network configuration parameters. For instance, for a particular network misconfiguration, there may be multiple UEs reporting the same issue. To avoid any potential overlap in reporting, the UE 115-a may determine when to report by randomly selecting a time in the reporting period configured by control signaling received from a network entity (e.g., 1-5 milliseconds after being connected). For instance, the UE 115-a may receive an indication of a reporting period for transmitting the report 210 indicating the one or more network configuration parameters. In such cases, the UE 115-a may transmit the report 210 within the reporting period.

In some examples, the UE 115-a may transmit the report 210 if the identified problem persists (e.g., if an issue related to a potential network misconfiguration persists). Additionally, or alternatively, the first network entity 105-a may advertise (e.g., in a system information block) a threshold (e.g., a probability of reporting), or a timer value such that the first network entity 105-a may manage a quantity of how many UEs report the problem. For example, if the first network entity 105-a detects a problem and still sees many UEs sending reports related to the issue, the first network entity 105-a may indicate the UEs to refrain from reporting for a period (to save on communication resources). In such cases, the UE 115-a may receive a system information block indicating a timer for transmitting the report indicating the one or more network configuration parameters, where the report 210 may be transmitted based on expiration of the timer.

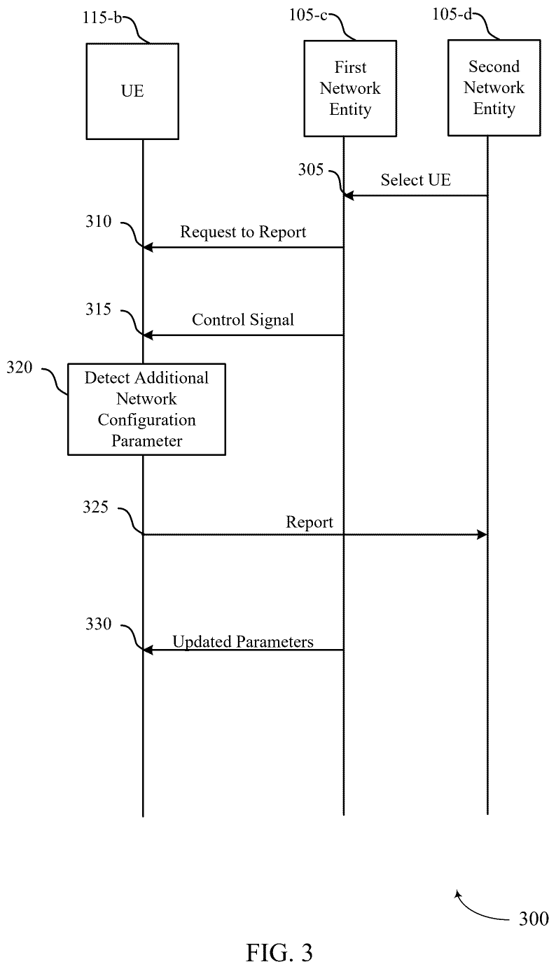

FIG. 3 shows an example of a process flow 300 that supports techniques for network misconfiguration reporting in accordance with one or more aspects of the present disclosure. The process flow 300 includes a UE 115-b, a first network entity 105-c, and a second network entity 105-d, which may be examples of the corresponding devices as described with respect to FIGS. 1 and 2.

In the following description of the process flow 300, the operations between the UE 115-b, the first network entity 105-c, and the second network entity 105-d may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

At 305, the second network entity 105-d may select one or more UEs for reporting one or more network configuration parameters. At 310, the UE 115-b may receive, from the first network entity 105-c, a request to report one or more network configuration parameters associated with monitoring for a potential network misconfiguration of one or more network functions at the UE 115-b. The UE 115-b may receive, from the first network entity 105-c, the information about the second network entity, to which report is transmitted. The information about the second network entity may include an IP address of the second network entity, an identifier of the second network entity, or any combination thereof.

At 315, the UE 115-b may receive, from a serving cell or from a neighbor cell, control signaling indicating the one or more network configuration parameters associated with the one or more network functions at the UE 115-b. At 320, the UE 115-b may detect a first network configuration parameter in addition to the one or more network configuration parameters. In some examples, the first network configuration parameter may be associated with a potential network misconfiguration detected at the UE 115-b. For example, the UE 115-b may identify the first network configuration parameter is associated with the potential network misconfiguration based on a value of the first network configuration parameter indicated in the control signaling differing from a historical value of the first network configuration parameter or differing from a value indicated by one or more neighbor cells.

At 325, the UE 115-b may transmit, to the second network entity 105-d and in response to the request, a report indicating the one or more network configuration parameters. In some examples, the UE 115-b may report the first network configuration parameter in addition to the one or more network configuration parameters. In some examples, the UE 115-b may send the report to the first network entity 105-c, which may then forward the report to the second network entity 105-c. At 330, the UE 115-b may receive, from the first network entity 105-c and based on the report, at least one updated network configuration parameter corresponding to at least one network function of the one or more network functions.

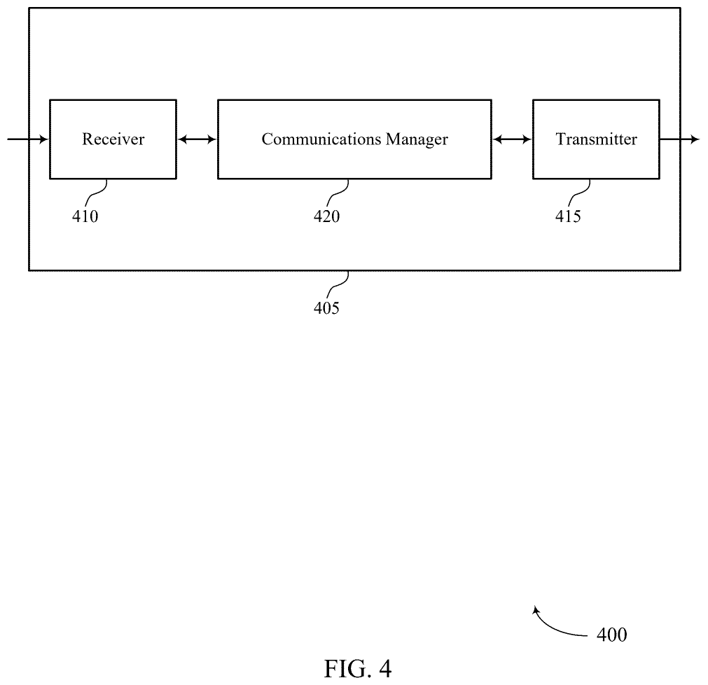

FIG. 4 shows a block diagram 400 of a device 405 that supports techniques for network misconfiguration reporting in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for network misconfiguration reporting). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for network misconfiguration reporting). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for network misconfiguration reporting as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, from a first network entity, a request to report one or more network configuration parameters associated with monitoring for a potential network misconfiguration of one or more network functions at the UE. The communications manager 420 is capable of, configured to, or operable to support a means for receiving, from a serving cell or from a neighbor cell, control signaling indicating the one or more network configuration parameters associated with the one or more network functions at the UE. The communications manager 420 is capable of, configured to, or operable to support a means for transmitting, to a second network entity in response to the request, a report indicating the one or more network configuration parameters. The communications manager 420 is capable of, configured to, or operable to support a means for receiving, from the first network entity and based on the report, at least one updated network configuration parameter corresponding to at least one network function of the one or more network functions.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources.

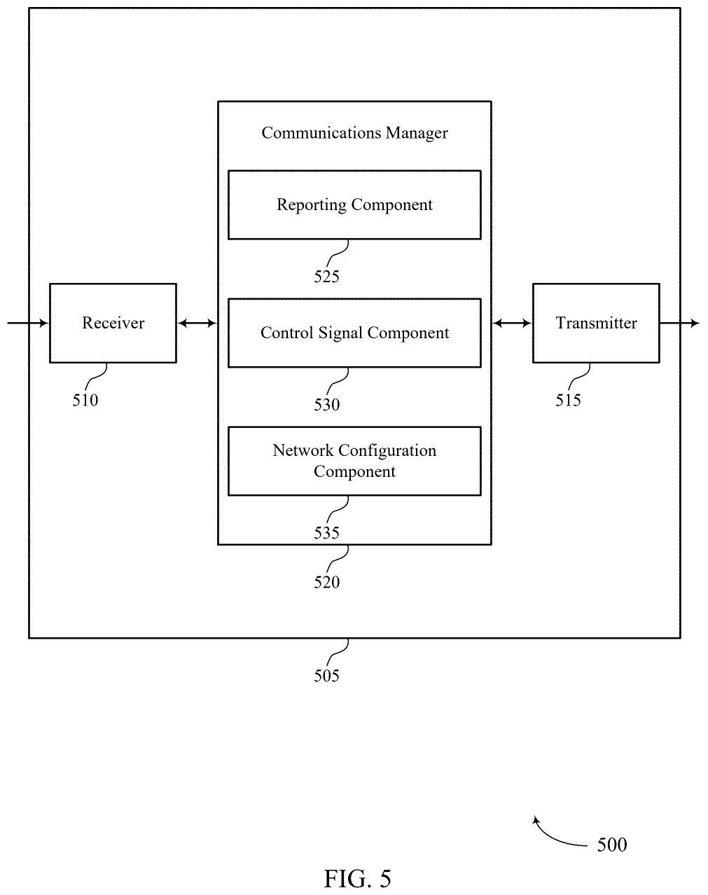

FIG. 5 shows a block diagram 500 of a device 505 that supports techniques for network misconfiguration reporting in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for network misconfiguration reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for network misconfiguration reporting). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for network misconfiguration reporting as described herein. For example, the communications manager 520 may include a reporting component 525, a control signal component 530, a network configuration component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The reporting component 525 is capable of, configured to, or operable to support a means for receiving, from a first network entity, a request to report one or more network configuration parameters associated with monitoring for a potential network misconfiguration of one or more network functions at the UE. The control signal component 530 is capable of, configured to, or operable to support a means for receiving, from a serving cell or from a neighbor cell, control signaling indicating the one or more network configuration parameters associated with the one or more network functions at the UE. The reporting component 525 is capable of, configured to, or operable to support a means for transmitting, to a second network entity in response to the request, a report indicating the one or more network configuration parameters. The network configuration component 535 is capable of, configured to, or operable to support a means for receiving, from the first network entity and based on the report, at least one updated network configuration parameter corresponding to at least one network function of the one or more network functions.

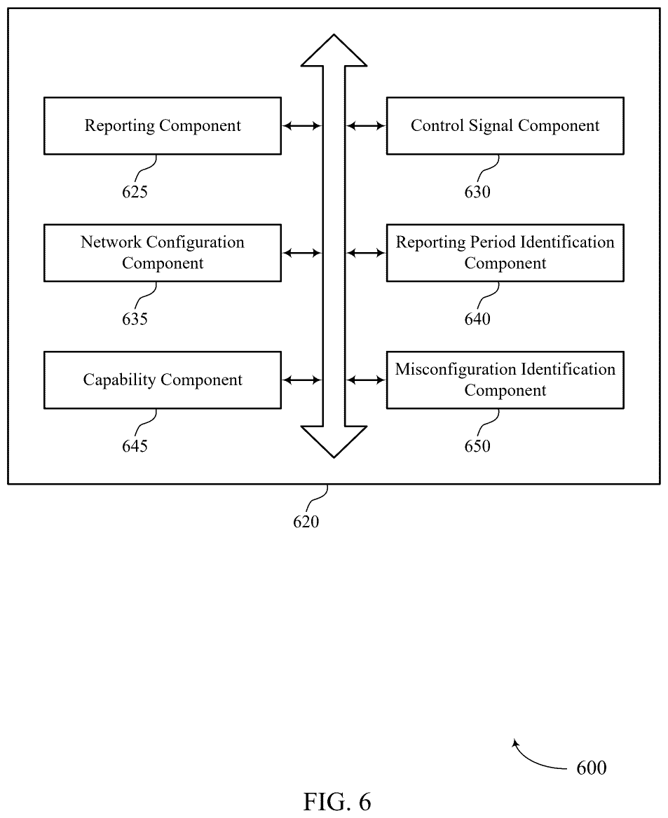

FIG. 6 shows a block diagram 600 of a communications manager 620 that supports techniques for network misconfiguration reporting in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for network misconfiguration reporting as described herein. For example, the communications manager 620 may include a reporting component 625, a control signal component 630, a network configuration component 635, a reporting period identification component 640, a capability component 645, a misconfiguration identification component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The reporting component 625 is capable of, configured to, or operable to support a means for receiving, from a first network entity, a request to report one or more network configuration parameters associated with monitoring for a potential network misconfiguration of one or more network functions at the UE. The control signal component 630 is capable of, configured to, or operable to support a means for receiving, from a serving cell or from a neighbor cell, control signaling indicating the one or more network configuration parameters associated with the one or more network functions at the UE. In some examples, the reporting component 625 is capable of, configured to, or operable to support a means for transmitting, to a second network entity in response to the request, a report indicating the one or more network configuration parameters. The network configuration component 635 is capable of, configured to, or operable to support a means for receiving, from the first network entity and based on the report, at least one updated network configuration parameter corresponding to at least one network function of the one or more network functions.

In some examples, to support transmitting the report, the reporting component 625 is capable of, configured to, or operable to support a means for transmitting the report indicating a first network configuration parameter in addition to the one or more network configuration parameters, where the first network configuration parameter is associated with a potential network misconfiguration detected at the UE.

In some examples, the misconfiguration identification component 650 is capable of, configured to, or operable to support a means for identifying the first network configuration parameter is associated with the potential network misconfiguration based on a value of the first network configuration parameter indicated in the control signaling differing from a historical value of the first network configuration parameter or differing from a value indicated by one or more neighbor cells.

In some examples, a difference between the value of the first network configuration parameter indicated in the control signaling and the historical value of the first network configuration parameter satisfies a first threshold. In some examples, a difference between the value of the first network configuration parameter indicated in the control signaling and the value indicated by the one or more neighbor cells satisfies a second threshold, or both.

In some examples, the reporting period identification component 640 is capable of, configured to, or operable to support a means for receiving an indication of a reporting period for transmitting the report indicating the one or more network configuration parameters, where the report is transmitted within the reporting period.

In some examples, the reporting component 625 is capable of, configured to, or operable to support a means for receiving a system information block indicating a probability for transmitting the report indicating the one or more network configuration parameters, where the report is transmitted based on the one or more network configuration parameters based on the probability.

In some examples, the reporting component 625 is capable of, configured to, or operable to support a means for receiving a system information block indicating a timer for transmitting the report indicating the one or more network configuration parameters, where the report is transmitted based on expiration of the timer.

In some examples, the one or more network configuration parameters include at least one of a master information block parameter, a system information block parameter, a radio resource control configuration parameter, a deviation from neighboring cells, a deviation from one or more historical configurations, or any combination thereof.

In some examples, the capability component 645 is capable of, configured to, or operable to support a means for transmitting a capability report indicating that the UE is capable of transmitting the report or identifying a potential network misconfiguration or both, where the request is received based on the capability report. In some examples, the request is based on a state of the UE or a power level at the UE or both.

In some examples, the at least one updated network configuration parameter is included in at least one of a system information block message, a radio resource control message, or a non-access stratum message.

In some examples, the network configuration component 635 is capable of, configured to, or operable to support a means for communicating one or more messages with the serving cell or the neighbor cell based on the at least one updated network configuration parameter.

In some examples, the request includes an identifier associated with the second network entity receiving the report indicating the one or more network configuration parameters. In some examples, the first network entity and the second network entity are collocated. In some examples, the first network entity and the second network entity are same.

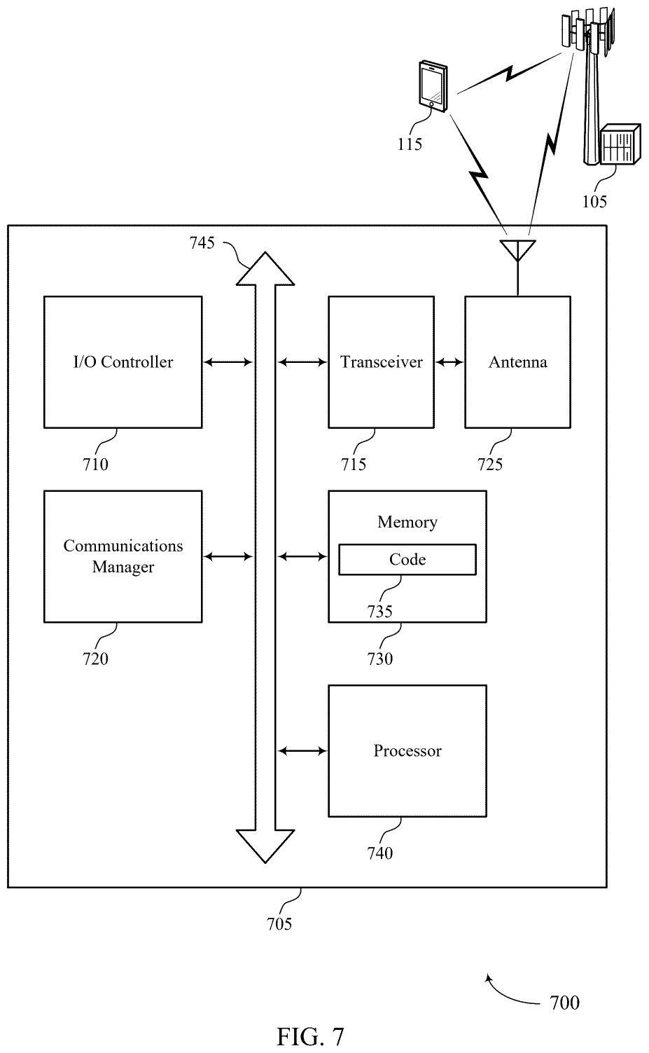

FIG. 7 shows a diagram of a system 700 including a device 705 that supports techniques for network misconfiguration reporting in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for network misconfiguration reporting). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, from a first network entity, a request to report one or more network configuration parameters associated with monitoring for a potential network misconfiguration of one or more network functions at the UE. The communications manager 720 is capable of, configured to, or operable to support a means for receiving, from a serving cell or from a neighbor cell, control signaling indicating the one or more network configuration parameters associated with the one or more network functions at the UE. The communications manager 720 is capable of, configured to, or operable to support a means for transmitting, to a second network entity in response to the request, a report indicating the one or more network configuration parameters. The communications manager 720 is capable of, configured to, or operable to support a means for receiving, from the first network entity and based on the report, at least one updated network configuration parameter corresponding to at least one network function of the one or more network functions.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for network misconfiguration reporting as described herein, or the at least one processor 740 and the at least one memory 730 may be otherwise configured to, individually or collectively, perform or support such operations.

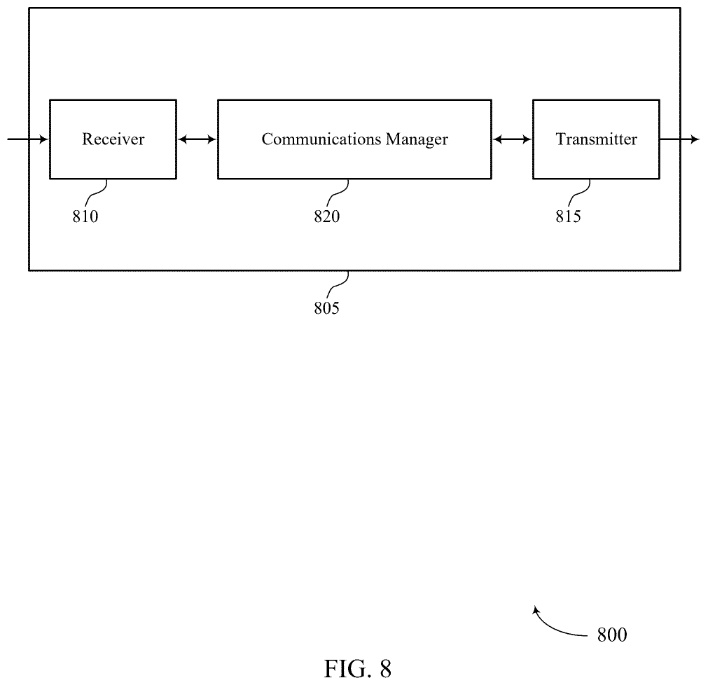

FIG. 8 shows a block diagram 800 of a device 805 that supports techniques for network misconfiguration reporting in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for network misconfiguration reporting as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting a request for a UE to report one or more network configuration parameters associated with monitoring for a potential network misconfiguration of one or more network functions at the UE. The communications manager 820 is capable of, configured to, or operable to support a means for outputting control signaling indicating the one or more network configuration parameters associated with the one or more network functions at the UE. The communications manager 820 is capable of, configured to, or operable to support a means for outputting, based on a report indicating the one or more network configuration parameters, at least one updated network configuration parameter corresponding to at least one network function of the one or more network functions.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

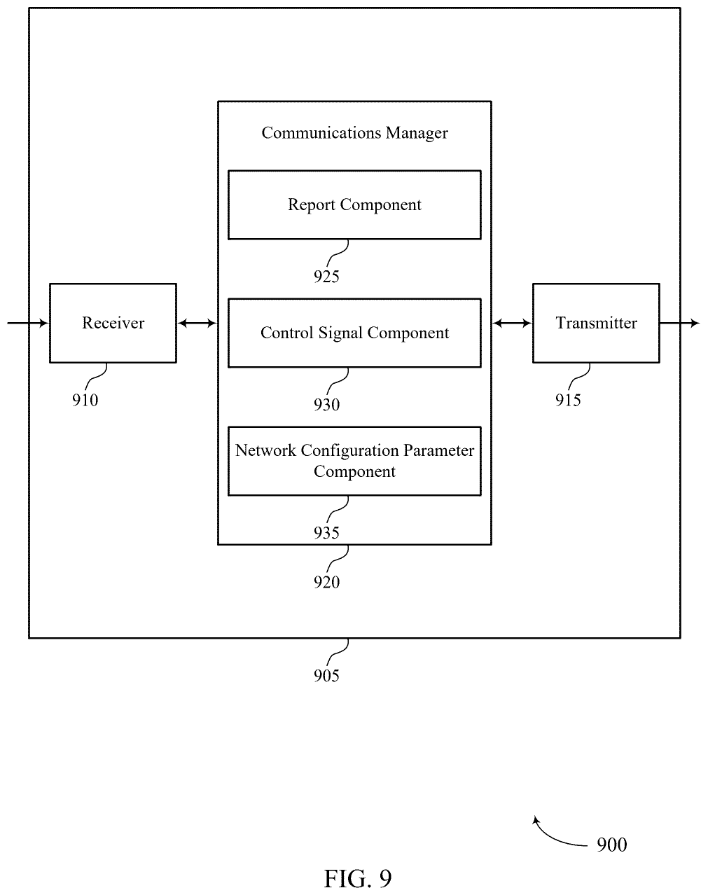

FIG. 9 shows a block diagram 900 of a device 905 that supports techniques for network misconfiguration reporting in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for network misconfiguration reporting as described herein. For example, the communications manager 920 may include a report component 925, a control signal component 930, a network configuration parameter component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The report component 925 is capable of, configured to, or operable to support a means for outputting a request for a UE to report one or more network configuration parameters associated with monitoring for a potential network misconfiguration of one or more network functions at the UE. The control signal component 930 is capable of, configured to, or operable to support a means for outputting control signaling indicating the one or more network configuration parameters associated with the one or more network functions at the UE. The network configuration parameter component 935 is capable of, configured to, or operable to support a means for outputting, based on a report indicating the one or more network configuration parameters, at least one updated network configuration parameter corresponding to at least one network function of the one or more network functions.

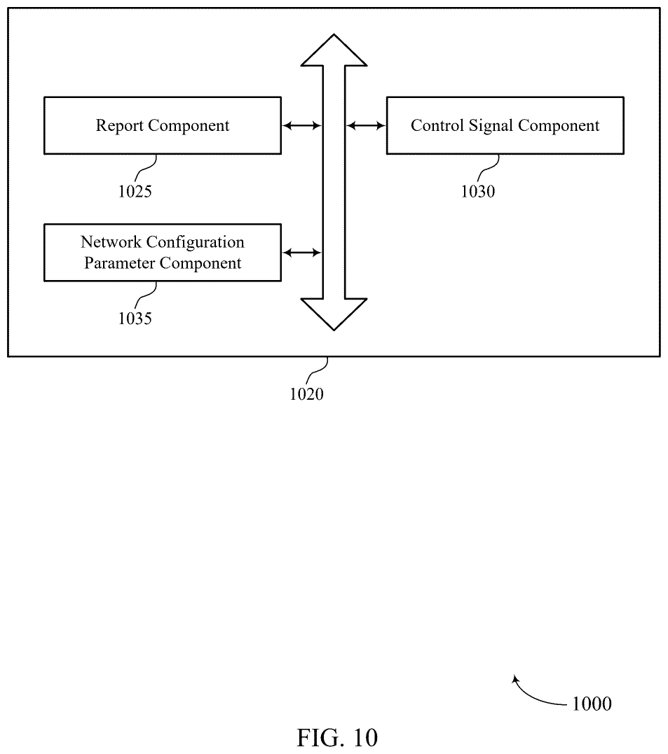

FIG. 10 shows a block diagram 1000 of a communications manager 1020 that supports techniques for network misconfiguration reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for network misconfiguration reporting as described herein. For example, the communications manager 1020 may include a report component 1025, a control signal component 1030, a network configuration parameter component 1035, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The report component 1025 is capable of, configured to, or operable to support a means for outputting a request for a UE to report one or more network configuration parameters associated with monitoring for a potential network misconfiguration of one or more network functions at the UE. The control signal component 1030 is capable of, configured to, or operable to support a means for outputting control signaling indicating the one or more network configuration parameters associated with the one or more network functions at the UE. The network configuration parameter component 1035 is capable of, configured to, or operable to support a means for outputting, based on a report indicating the one or more network configuration parameters, at least one updated network configuration parameter corresponding to at least one network function of the one or more network functions.

In some examples, the report indicates a first network configuration parameter in addition to the one or more network configuration parameters. In some examples, the first network configuration parameter is associated with a potential network misconfiguration detected at the UE.

In some examples, the report component 1025 is capable of, configured to, or operable to support a means for receiving, from a second network entity, a request to configure the UE to report the one or more network configuration parameters. In some examples, the network entity and the second network entity are collocated. In some examples, the network entity and the second network entity are same.

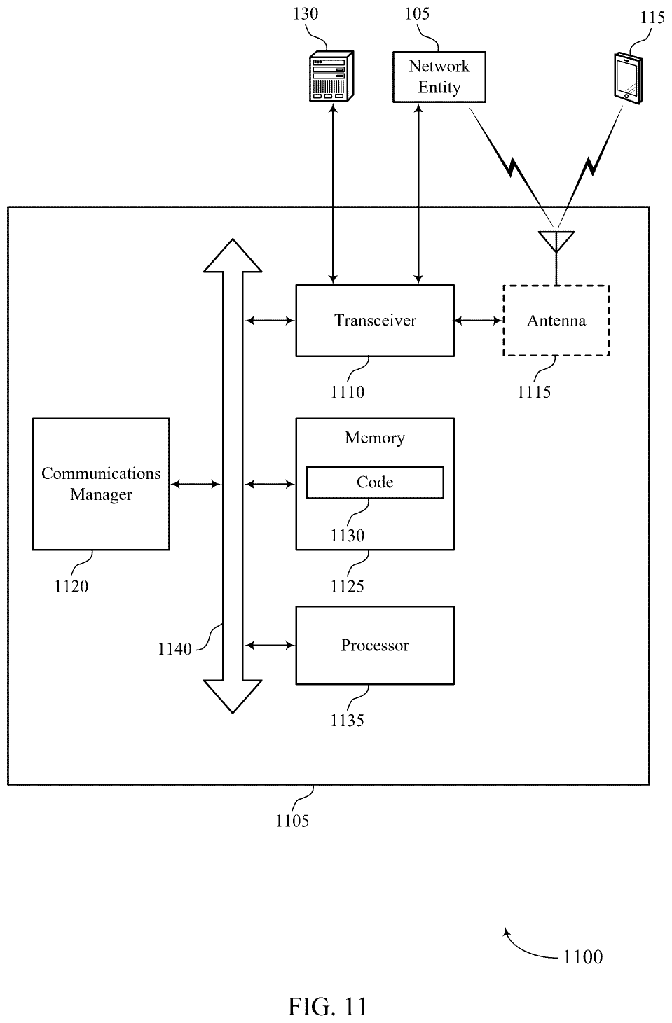

FIG. 11 shows a diagram of a system 1100 including a device 1105 that supports techniques for network misconfiguration reporting in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for network misconfiguration reporting). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting a request for a UE to report one or more network configuration parameters associated with monitoring for a potential network misconfiguration of one or more network functions at the UE. The communications manager 1120 is capable of, configured to, or operable to support a means for outputting control signaling indicating the one or more network configuration parameters associated with the one or more network functions at the UE. The communications manager 1120 is capable of, configured to, or operable to support a means for outputting, based on a report indicating the one or more network configuration parameters, at least one updated network configuration parameter corresponding to at least one network function of the one or more network functions.

By including or configuring the communications manager 1120 in accordance with examples as described herein, the device 1105 may support techniques for improved communication reliability, reduced latency, improved user experience related to reduced processing, reduced power consumption, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for network misconfiguration reporting as described herein, or the at least one processor 1135 and the at least one memory 1125 may be otherwise configured to, individually or collectively, perform or support such operations.

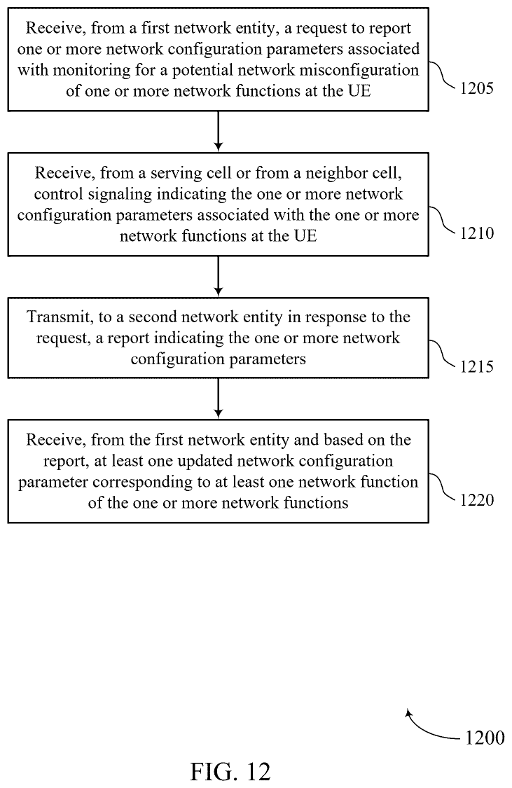

FIG. 12 shows a flowchart illustrating a method 1200 that supports techniques for network misconfiguration reporting in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a first network entity, a request to report one or more network configuration parameters associated with monitoring for a potential network misconfiguration of one or more network functions at the UE. The operations of 1205 may be performed in accordance with examples as disclosed herein. In some examples, aspects of the operations of 1205 may be performed by a reporting component 625 as described with reference to FIG. 6.

At 1210, the method may include receiving, from a serving cell or from a neighbor cell, control signaling indicating the one or more network configuration parameters associated with the one or more network functions at the UE. The operations of 1210 may be performed in accordance with examples as disclosed herein. In some examples, aspects of the operations of 1210 may be performed by a control signal component 630 as described with reference to FIG. 6.

At 1215, the method may include transmitting, to a second network entity in response to the request, a report indicating the one or more network configuration parameters. The operations of 1215 may be performed in accordance with examples as disclosed herein. In some examples, aspects of the operations of 1215 may be performed by a reporting component 625 as described with reference to FIG. 6.

At 1220, the method may include receiving, from the first network entity and based on the report, at least one updated network configuration parameter corresponding to at least one network function of the one or more network functions. The operations of 1220 may be performed in accordance with examples as disclosed herein. In some examples, aspects of the operations of 1220 may be performed by a network configuration component 635 as described with reference to FIG. 6.

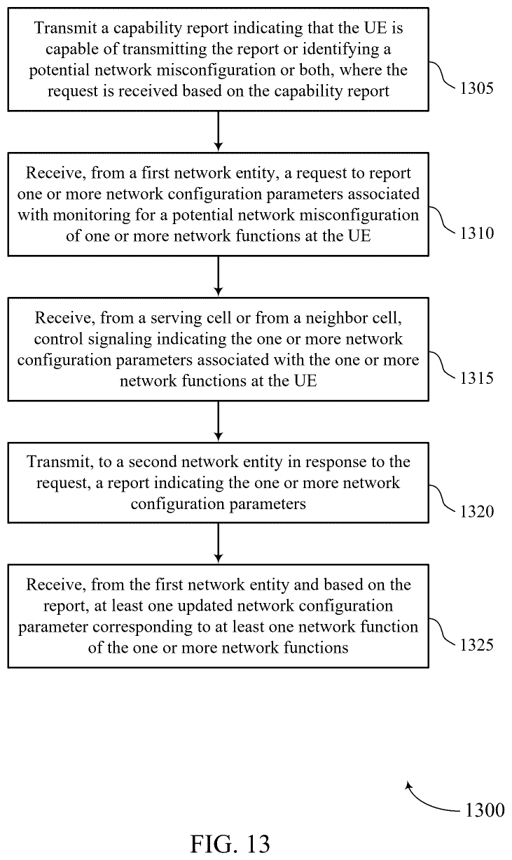

FIG. 13 shows a flowchart illustrating a method 1300 that supports techniques for network misconfiguration reporting in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include transmitting a capability report indicating that the UE is capable of transmitting the report or identifying a potential network misconfiguration or both, where the request is received based on the capability report. The operations of 1305 may be performed in accordance with examples as disclosed herein. In some examples, aspects of the operations of 1305 may be performed by a capability component 645 as described with reference to FIG. 6.

At 1310, the method may include receiving, from a first network entity, a request to report one or more network configuration parameters associated with monitoring for a potential network misconfiguration of one or more network functions at the UE. The operations of 1310 may be performed in accordance with examples as disclosed herein. In some examples, aspects of the operations of 1310 may be performed by a reporting component 625 as described with reference to FIG. 6.

At 1315, the method may include receiving, from a serving cell or from a neighbor cell, control signaling indicating the one or more network configuration parameters associated with the one or more network functions at the UE. The operations of 1315 may be performed in accordance with examples as disclosed herein. In some examples, aspects of the operations of 1315 may be performed by a control signal component 630 as described with reference to FIG. 6.

At 1320, the method may include transmitting, to a second network entity in response to the request, a report indicating the one or more network configuration parameters. The operations of 1320 may be performed in accordance with examples as disclosed herein. In some examples, aspects of the operations of 1320 may be performed by a reporting component 625 as described with reference to FIG. 6.

At 1325, the method may include receiving, from the first network entity and based on the report, at least one updated network configuration parameter corresponding to at least one network function of the one or more network functions. The operations of 1325 may be performed in accordance with examples as disclosed herein. In some examples, aspects of the operations of 1325 may be performed by a network configuration component 635 as described with reference to FIG. 6.

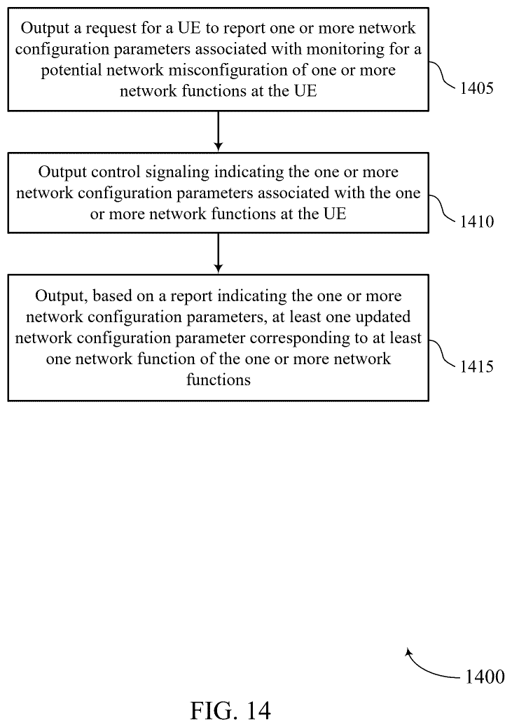

FIG. 14 shows a flowchart illustrating a method 1400 that supports techniques for network misconfiguration reporting in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting a request for a UE to report one or more network configuration parameters associated with monitoring for a potential network misconfiguration of one or more network functions at the UE. The operations of 1405 may be performed in accordance with examples as disclosed herein. In some examples, aspects of the operations of 1405 may be performed by a report component 1025 as described with reference to FIG. 10.

At 1410, the method may include outputting control signaling indicating the one or more network configuration parameters associated with the one or more network functions at the UE. The operations of 1410 may be performed in accordance with examples as disclosed herein. In some examples, aspects of the operations of 1410 may be performed by a control signal component 1030 as described with reference to FIG. 10.

At 1415, the method may include outputting, based on a report indicating the one or more network configuration parameters, at least one updated network configuration parameter corresponding to at least one network function of the one or more network functions. The operations of 1415 may be performed in accordance with examples as disclosed herein. In some examples, aspects of the operations of 1415 may be performed by a network configuration parameter component 1035 as described with reference to FIG. 10.

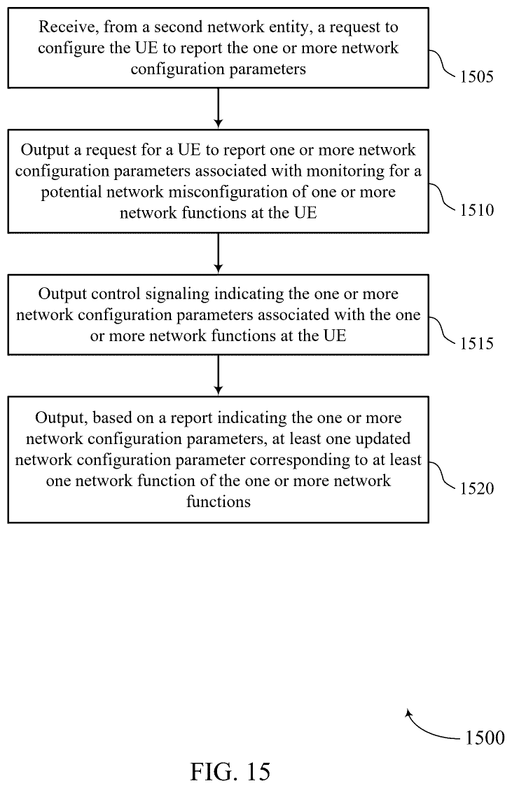

FIG. 15 shows a flowchart illustrating a method 1500 that supports techniques for network misconfiguration reporting in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a second network entity, a request to configure the UE to report the one or more network configuration parameters. The operations of 1505 may be performed in accordance with examples as disclosed herein. In some examples, aspects of the operations of 1505 may be performed by a report component 1025 as described with reference to FIG. 10.

At 1510, the method may include outputting a request for a UE to report one or more network configuration parameters associated with monitoring for a potential network misconfiguration of one or more network functions at the UE. The operations of 1510 may be performed in accordance with examples as disclosed herein. In some examples, aspects of the operations of 1510 may be performed by a report component 1025 as described with reference to FIG. 10.

At 1515, the method may include outputting control signaling indicating the one or more network configuration parameters associated with the one or more network functions at the UE. The operations of 1515 may be performed in accordance with examples as disclosed herein. In some examples, aspects of the operations of 1515 may be performed by a control signal component 1030 as described with reference to FIG. 10.

At 1520, the method may include outputting, based on a report indicating the one or more network configuration parameters, at least one updated network configuration parameter corresponding to at least one network function of the one or more network functions. The operations of 1520 may be performed in accordance with examples as disclosed herein. In some examples, aspects of the operations of 1520 may be performed by a network configuration parameter component 1035 as described with reference to FIG. 10.

The following provides an overview of aspects of the present disclosure:
Aspect 1: A method for wireless communications at a UE, comprising: receiving, from a first network entity, a request to report one or more network configuration parameters associated with monitoring for a potential network misconfiguration of one or more network functions at the UE; receiving, from a serving cell or from a neighbor cell, control signaling indicating the one or more network configuration parameters associated with the one or more network functions at the UE; transmitting, to a second network entity in response to the request, a report indicating the one or more network configuration parameters; and receiving, from the first network entity and based at least in part on the report, at least one updated network configuration parameter corresponding to at least one network function of the one or more network functions.
Aspect 2: The method of aspect 1, wherein transmitting the report further comprises: transmitting the report indicating a first network configuration parameter in addition to the one or more network configuration parameters, wherein the first network configuration parameter is associated with a potential network misconfiguration detected at the UE.
Aspect 3: The method of aspect 2, further comprising: identifying the first network configuration parameter is associated with the potential network misconfiguration based at least in part on a value of the first network configuration parameter indicated in the control signaling differing from a historical value of the first network configuration parameter or differing from a value indicated by one or more neighbor cells.
Aspect 4: The method of aspect 3, wherein a difference between the value of the first network configuration parameter indicated in the control signaling and the historical value of the first network configuration parameter satisfies a first threshold, or a difference between the value of the first network configuration parameter indicated in the control signaling and the value indicated by the one or more neighbor cells satisfies a second threshold, or both.
Aspect 5: The method of any of aspects 1 through 4, further comprising: receiving an indication of a reporting period for transmitting the report indicating the one or more network configuration parameters, wherein the report is transmitted within the reporting period.
Aspect 6: The method of any of aspects 1 through 5, further comprising: receiving a system information block indicating a probability for transmitting the report indicating the one or more network configuration parameters, wherein the report is transmitted based at least in part on the one or more network configuration parameters based on the probability.
Aspect 7: The method of any of aspects 1 through 6, further comprising: receiving a system information block indicating a timer for transmitting the report indicating the one or more network configuration parameters, wherein the report is transmitted based at least in part on expiration of the timer.
Aspect 8: The method of any of aspects 1 through 7, wherein the one or more network configuration parameters comprise at least one of a master information block parameter, a system information block parameter, a radio resource control configuration parameter, a deviation from neighboring cells, a deviation from one or more historical configurations, or any combination thereof.
Aspect 9: The method of any of aspects 1 through 8, further comprising: transmitting a capability report indicating that the UE is capable of transmitting the report or identifying a potential network misconfiguration or both, wherein the request is received based at least in part on the capability report.
Aspect 10: The method of any of aspects 1 through 9, wherein the request is based at least in part on a state of the UE or a power level at the UE or both.
Aspect 11: The method of any of aspects 1 through 10, wherein the at least one updated network configuration parameter is included in at least one of a system information block message, a radio resource control message, or a non-access stratum message.
Aspect 12: The method of any of aspects 1 through 11, further comprising: communicating one or more messages with the serving cell or the neighbor cell based at least in part on the at least one updated network configuration parameter.
Aspect 13: The method of any of aspects 1 through 12, wherein the request includes an identifier associated with the second network entity receiving the report indicating the one or more network configuration parameters.
Aspect 14: The method of any of aspects 1 through 13, wherein the first network entity and the second network entity are collocated, or the first network entity and the second network entity are same..
Aspect 15: A method for wireless communications at a network entity, comprising: outputting a request for a UE to report one or more network configuration parameters associated with monitoring for a potential network misconfiguration of one or more network functions at the UE; outputting control signaling indicating the one or more network configuration parameters associated with the one or more network functions at the UE; and outputting, based at least in part on a report indicating the one or more network configuration parameters, at least one updated network configuration parameter corresponding to at least one network function of the one or more network functions.
Aspect 16: The method of aspect 15, wherein the report indicates a first network configuration parameter in addition to the one or more network configuration parameters, the first network configuration parameter is associated with a potential network misconfiguration detected at the UE.
Aspect 17: The method of any of aspects 15 through 16, further comprising: receiving, from a second network entity, a request to configure the UE to report the one or more network configuration parameters.
Aspect 18: The method of aspect 17, wherein the network entity and the second network entity are collocated, or the network entity and the second network entity are same.
Aspect 19: A UE for wireless communications, comprising one or more memories storing processor-executable code, and one or more processors coupled with the one or more memories and individually or collectively operable to execute the code to cause the UE to perform a method of any of aspects 1 through 14.
Aspect 20: A UE for wireless communications, comprising at least one means for performing a method of any of aspects 1 through 14.
Aspect 21: A non-transitory computer-readable medium storing code for wireless communications, the code comprising instructions executable by one or more processors to perform a method of any of aspects 1 through 14.
Aspect 22: A network entity for wireless communications, comprising one or more memories storing processor-executable code, and one or more processors coupled with the one or more memories and individually or collectively operable to execute the code to cause the network entity to perform a method of any of aspects 15 through 18.
Aspect 23: A network entity for wireless communications, comprising at least one means for performing a method of any of aspects 15 through 18.
Aspect 24: A non-transitory computer-readable medium storing code for wireless communications, the code comprising instructions executable by one or more processors to perform a method of any of aspects 15 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a first network entity, a request to report one or more network configuration parameters associated with monitoring for a potential network misconfiguration of one or more network functions at the UE;
receive, from a serving cell or from a neighbor cell, control signaling indicating the one or more network configuration parameters associated with the one or more network functions at the UE;
transmit, to a second network entity in response to the request, a report indicating the one or more network configuration parameters; and
receive, from the first network entity and based at least in part on the report, at least one updated network configuration parameter corresponding to at least one network function of the one or more network functions.

2. The UE of claim 1, wherein, to transmit the report, the one or more processors are individually or collectively further operable to execute the code to cause the UE to:
transmit the report indicating a first network configuration parameter in addition to the one or more network configuration parameters, wherein the first network configuration parameter is associated with a potential network misconfiguration detected at the UE.

3. The UE of claim 2, wherein the one or more processors are individually or collectively further operable to execute the code to cause the UE to:
identify the first network configuration parameter is associated with the potential network misconfiguration based at least in part on a value of the first network configuration parameter indicated in the control signaling differing from a historical value of the first network configuration parameter or differing from a value indicated by one or more neighbor cells.

4. The UE of claim 3, wherein:
a difference between the value of the first network configuration parameter indicated in the control signaling and the historical value of the first network configuration parameter satisfies a first threshold, or
a difference between the value of the first network configuration parameter indicated in the control signaling and the value indicated by the one or more neighbor cells satisfies a second threshold, or both.

5. The UE of claim 1, wherein the one or more processors are individually or collectively further operable to execute the code to cause the UE to:
receive an indication of a reporting period for transmitting the report indicating the one or more network configuration parameters, wherein the report is transmitted within the reporting period.

6. The UE of claim 1, wherein the one or more processors are individually or collectively further operable to execute the code to cause the UE to:
receive a system information block indicating a probability for transmitting the report indicating the one or more network configuration parameters, wherein the report is transmitted based at least in part on the one or more network configuration parameters based on the probability.

7. The UE of claim 1, wherein the one or more processors are individually or collectively further operable to execute the code to cause the UE to:
receive a system information block indicating a timer for transmitting the report indicating the one or more network configuration parameters, wherein the report is transmitted based at least in part on expiration of the timer.

8. The UE of claim 1, wherein the one or more network configuration parameters comprise at least one of a master information block parameter, a system information block parameter, a radio resource control configuration parameter, a deviation from neighboring cells, a deviation from one or more historical configurations, or any combination thereof.

9. The UE of claim 1, wherein the one or more processors are individually or collectively further operable to execute the code to cause the UE to:
transmit a capability report indicating that the UE is capable of transmitting the report or identifying a potential network misconfiguration or both, wherein the request is received based at least in part on the capability report.

10. The UE of claim 1, wherein the request is based at least in part on a state of the UE or a power level at the UE or both.

11. The UE of claim 1, wherein the at least one updated network configuration parameter is included in at least one of a system information block message, a radio resource control message, or a non-access stratum message.

12. The UE of claim 1, wherein the one or more processors are individually or collectively further operable to execute the code to cause the UE to:
communicate one or more messages with the serving cell or the neighbor cell based at least in part on the at least one updated network configuration parameter.

13. The UE of claim 1, wherein the request includes an identifier associated with the second network entity receiving the report indicating the one or more network configuration parameters.

14. The UE of claim 1, wherein:
the first network entity and the second network entity are collocated, or
the first network entity and the second network entity are same.

15. A network entity, comprising:
one or more memories storing processor-executable code; and
one or more processors coupled with the one or more memories and individually or collectively operable to execute the code to cause the network entity to:
output a request for a user equipment (UE) to report one or more network configuration parameters associated with monitoring for a potential network misconfiguration of one or more network functions at the UE;
output control signaling indicating the one or more network configuration parameters associated with the one or more network functions at the UE; and
output, based at least in part on a report indicating the one or more network configuration parameters, at least one updated network configuration parameter corresponding to at least one network function of the one or more network functions.

16. The network entity of claim 15, wherein:
the report indicates a first network configuration parameter in addition to the one or more network configuration parameters,
the first network configuration parameter is associated with a potential network misconfiguration detected at the UE.

17. The network entity of claim 15, wherein the one or more processors are individually or collectively further operable to execute the code to cause the network entity to:
receive, from a second network entity, a request to configure the UE to report the one or more network configuration parameters.

18. The network entity of claim 17, wherein:
the network entity and the second network entity are collocated, or
the network entity and the second network entity are same.

19. A method for wireless communications at a user equipment (UE), comprising:
receiving, from a first network entity, a request to report one or more network configuration parameters associated with monitoring for a potential network misconfiguration of one or more network functions at the UE;
receiving, from a serving cell or from a neighbor cell, control signaling indicating the one or more network configuration parameters associated with the one or more network functions at the UE;
transmitting, to a second network entity in response to the request, a report indicating the one or more network configuration parameters; and
receiving, from the first network entity and based at least in part on the report, at least one updated network configuration parameter corresponding to at least one network function of the one or more network functions.

20. The method of claim 19, wherein transmitting the report further comprises:
transmitting the report indicating a first network configuration parameter in addition to the one or more network configuration parameters, wherein the first network configuration parameter is associated with a potential network misconfiguration detected at the UE.
